(19) United States
(12) Patent Application Publication
(10) Pub. No.: US 2002/0197960 A1
(43) Pub. Date: Dec. 26, 2002

(54) Communication clothes

(76) Inventors: Yung-Tang Lee, Taipei (TW); Shih-Min Wang, Taipei (TW)

Correspondence Address: BIRCH STEWART KOLASCH & BIRCH, PO BOX 747, FALLS CHURCH, VA, 22040-0747, US

(21) Appl. No.: 09/884,960

(22) Filed: Jun. 21, 2001

(51) Int. Cl. H04B 7/00

(52) U.S. Cl. 455/66; 455/90

(57) ABSTRACT

A communication clothes provides a communication connection to a mobile phone for hearing and conversing use. The clothes has a pocket to hold a connector which links respectively to a speaker and a microphone hidden on the collar, and also links to a keyboard hidden at a selected location on the clothes. An user may wear the clothes and engage the mobile phone with the connector in the pocket. The user may hear the incoming call and converse through the speaker and microphone located on the collar.

### FIELD OF THE INVENTION

The present invention relates to communication clothes and particularly clothes that can be connected with mobile phone signals, having a speaker and a microphone disposed thereon for receiving and sending messages.

### BACKGROUND OF THE INVENTION

Mobile phones employ a wireless transmission method to receive and send messages to allow users to communicate with other persons in a one-to-one fashion whenever they like and wherever they are. They have become the most popular personal electronic products today.

Most users now usually carry mobile phones in one of the following ways:

1. Fastening to a belt clip:

The belt clip generally consists of a clamp and a fastener. The clamp may be attached to the belt, and the fastener may be fastened to the mobile phone. Users attach the clip to the belt then fasten the mobile phone to the clip. The mobile phone thus may be hung on the waist. Most men adopt this method.

2. Holding in a handbag:

Many women wear clothes that do not have belts or clips for hanging mobile phones. They usually put the mobile phones in the handbags they carry with them.

3. Holding in the pockets or inner pouches of the outerwear or jackets:

Some users, men or women, tend to put mobile phones in the pockets or pouches of their clothes.

4. Hanging around the neck:

Some people tie a string to the mobile phone and put the string around their neck to carry the mobile phone. This is usually adopted for mobile phones of a smaller size.

All the carrying methods set forth above have disadvantages. For instance, when there is an incoming call, users have to retrieve the mobile phones from their belt clips, handbags, or clothes pockets, and use one hand to hold the phone and press the button to listen and speak. This may be impossible or inconvenient on many occasions, such as when both of a user's hands are occupied carrying goods, or when a user is standing on a moving bus or rapid transit vehicle. It is not unusual to see people fumbling awkwardly to retrieve their mobile phones when incoming calls are ringing. This could cause long delays and users may miss the incoming calls. Having a conversation while on a moving car with one hand holding the mobile phone is also uncomfortable. After the conversation is finished, it is equally bothersome to put the mobile phone back on the belt, or in the handbag or pocket.

There are mobile phones without handsets, which are connected to earpieces and microphones that are hung behind users' ears to overcome the aforesaid problems. Although the earphone technology works quite well at present, it has not been widely accepted for the mobile phone. One of the main reasons is that it is uncomfortable for most people to hang the earpieces and microphones behind their ears. Moreover, when in use, the earpiece and microphone are exposed and look awkward, like those used in the military or by telephone operators. This does not appeal to most people.

### SUMMARY OF THE INVENTION

The primary object of the invention is to provide communication clothes that are capable of receiving mobile phone signals.

The communication clothes according the invention consist of clothes worn by a user, a connector held in a pocket of the clothes, a speaker and a microphone hidden behind the collar and linked to the connector, and a keyboard disposed at a selected location of the clothes that is not visible from the outside. When in use, an user wears the clothes and engages the mobile phone with the connector in the pocket. When there is an incoming call, the user may hear and converse through the speaker and microphone located on the collar.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view a first embodiment of the invention.

FIG. 2A is a schematic view a second embodiment of the invention.

FIG. 2B is a fragmentary enlarged view the second embodiment.

FIG. 3 is a schematic view a third embodiment of the invention.

FIG. 4 is a schematic view a fourth embodiment of the invention.

FIGS. 5A and 5B are schematic views a fifth embodiment of the invention.

FIG. 6 is a schematic view a sixth embodiment of the invention.

### DESCRIPTION OF THE PREFERRED EMBODIMENTS

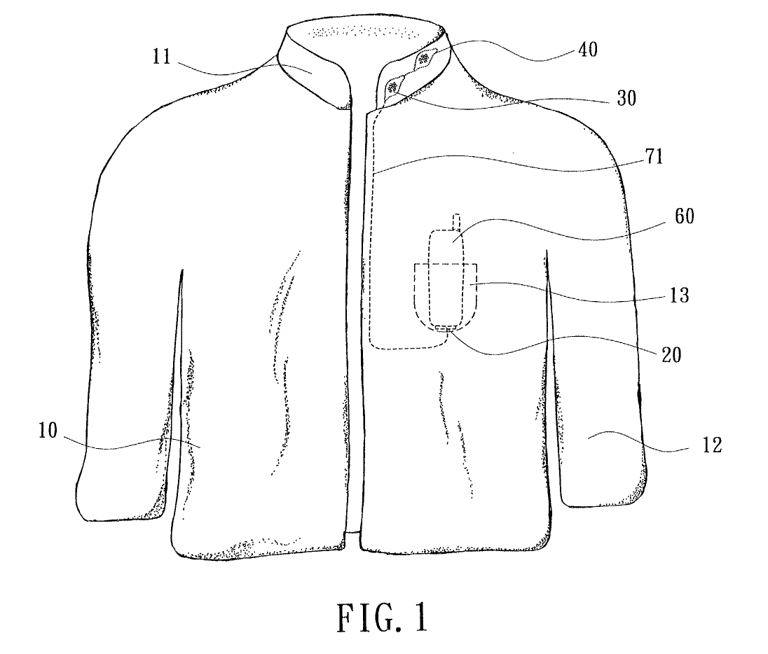

Referring to FIG. 1, the communication clothes of the present invention is for an user to wear and connect to the signals of a mobile phone 60. It includes at least a clothes 10, a connector 20, a speaker 30 and a microphone 40. The clothes 10 looks like an ordinary apparel such as a jacket, outerwear or suit (of course it may be any suitable clothes other than jackets, outerwear or suits). The drawing uses a jacket as an example. The clothes 10 may be worn by an user and includes at least a collar 11, sleeves 12 and a pocket 13. The pocket 13 may be located inside or outside the clothes 10.

The connector 20 is hidden in the clothes 10 at a selected location, preferably in the pocket 13. The speaker 30 and microphone 40 may be hidden in the clothes 10 at selected locations, preferably at the collar 11. The speaker 30 and microphone 40 are spaced from each other for a selected distance to avoid signal interference. The connector 20 is to connect the signals of the signal output port (not shown in the drawing) of the mobile phone 60. The speaker 30 is to broadcast the incoming audio signals of the mobile phone 60. The microphone 40 is to receive user's speaking voice and transmit to the mobile phone 60. The connector 20 connects through a first wire 71 to the speaker 30 and microphone 40 (the first wire 71 is preferably embedded in the rim stitches of the clothes 10 to avoid impediment to wearing of the clothes 10) for linking the signal output port of the mobile phone 60 to the connector 20 so that the mobile phone 60 can establish signal connection with the speaker 30 and microphone 40. When the mobile phone 60 receives incoming signals, the user may hear and converse through the speaker 30 and microphone 40 located at the collar 11. When there is too much outside interference, the user may unfold and erect the collar 11 to make the speaker 30 and microphone 40 closer to user's ears and mouth to get a better hearing and conversing effect.

The general mobile phones 60 have many different receiving modes for hearing the incoming calls, such as pressing the receiving button, or direct communication when the ring bell for the incoming call is activated. When the present invention is adapted for use when users are in the mass transportation vehicles or walking, the mobile phone 60 may be preset to the bell ring conversation mode. Then the mobile phone 60 may be placed in the pocket 13 of the clothes 10 to link to the connector 10. Thus users may directly hear or talk when receiving the incoming calls even users' hands are occupied such as holding goods, and no important messages will be missed.

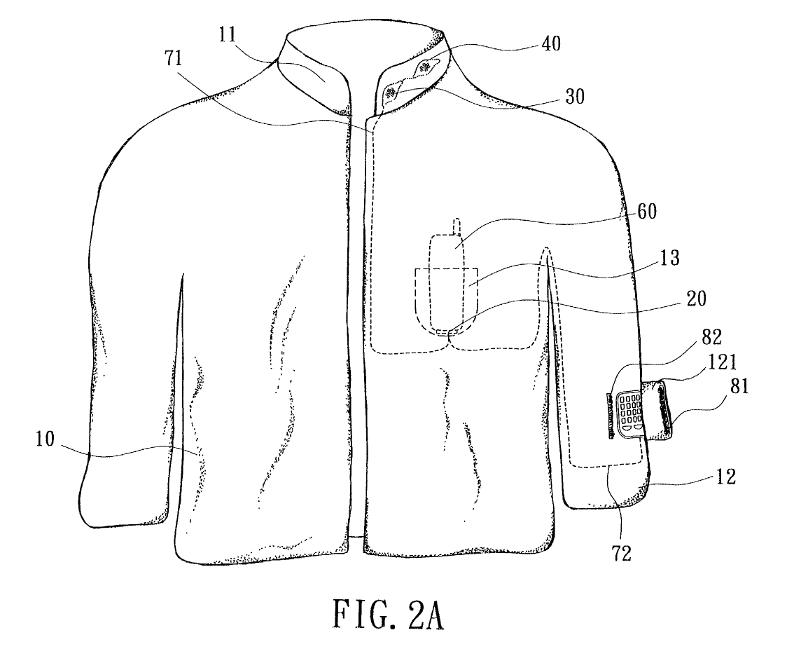

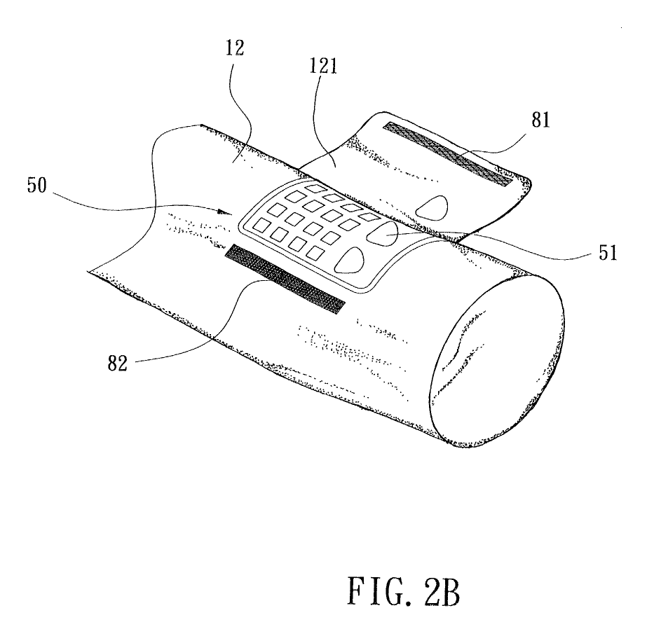

Referring to FIG. 2A, the present invention may further include a keyboard 50 located at a selection on the clothes 10, preferably at the opening end of a sleeve 12. The keyboard 50 links to the connector 20 through a second wire 72 (the second wire 72 is preferably embedded in the rim stitches of the clothes 10 to avoid impediment to wearing of the clothes 10). In order to match the clothes 10, the keyboard 50 is a membrane keyboard which has a plurality of push buttons 51 located thereon. The push buttons 51 includes numeral buttons, character buttons, selection buttons, a receiving button, and a cutoff button. The keyboard 50 links to the mobile phone 60 through the connector 20. If a general user sets the mobile phone 60 receiving mode through the receiving button, when there is an incoming call signal, the user may press the receiving button on the keyboard 50 to hear the incoming message. The push buttons 51 on the keyboard 50 may also allow users to enter input data into the mobile phone 60.

Referring to FIG. 2B, in order to make the keyboard 50 easier for users to operate, the keyboard 50 is preferably located at the opening end of the sleeve 12. Then an user may raise the arm for another hand to operate and press the buttons. To avoid the keyboard 50 spoiling the appearance of the clothes 10, a cover flap 121 may be provided and stitched on the sleeve 12 with Velcro strips 81 and 82 attached respectively on the cover flap 121 and sleeve 12, so that the Velcro strips 81 and 82 may make the cover flap 121 bonding to the sleeve 12 to hold the keyboard 50 securely and make the keyboard 50 not visible from outside. When in use, unfold the cover flap 121 to expose the keyboard 50. It is preferable to make the receiving button exposed even when the cover flap 121 is covering the keyboard 50 so that users may press the receiving button to take the incoming call without unfolding the cover flap 121.

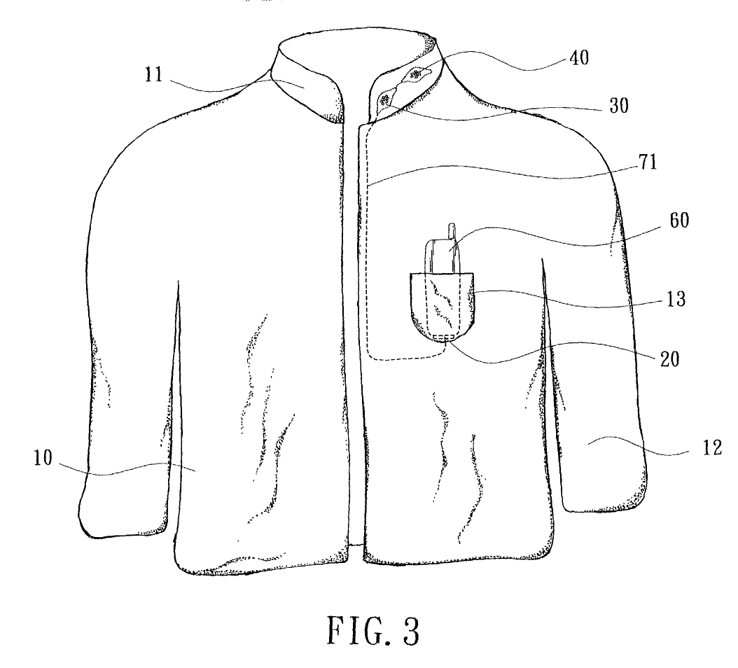

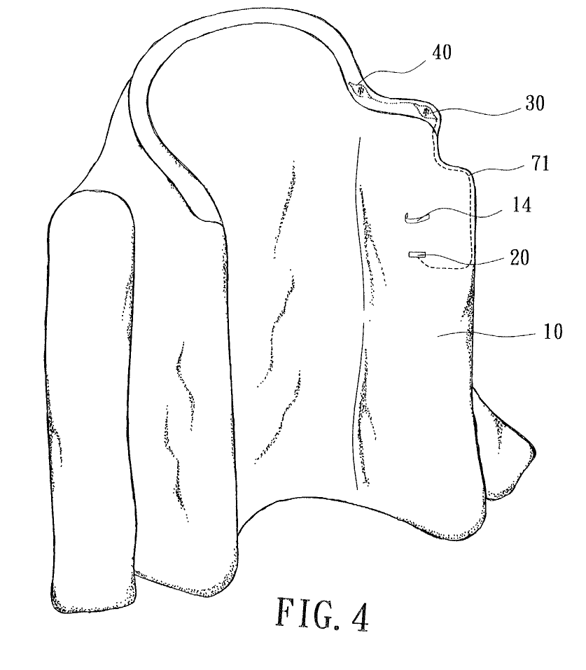

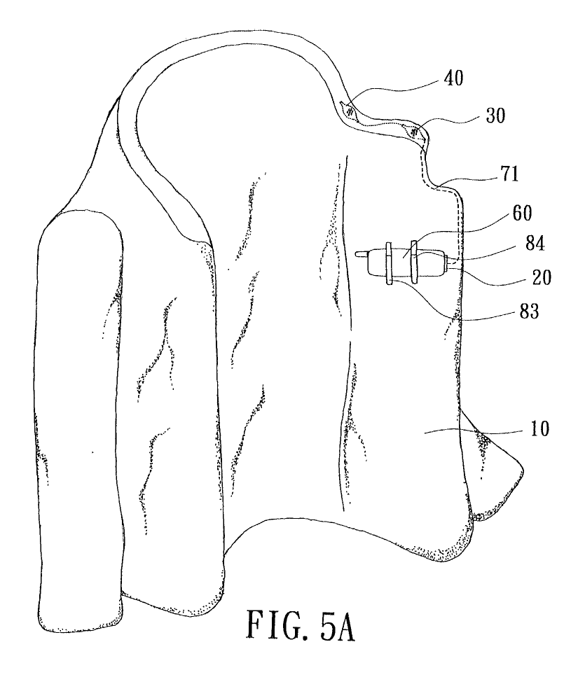

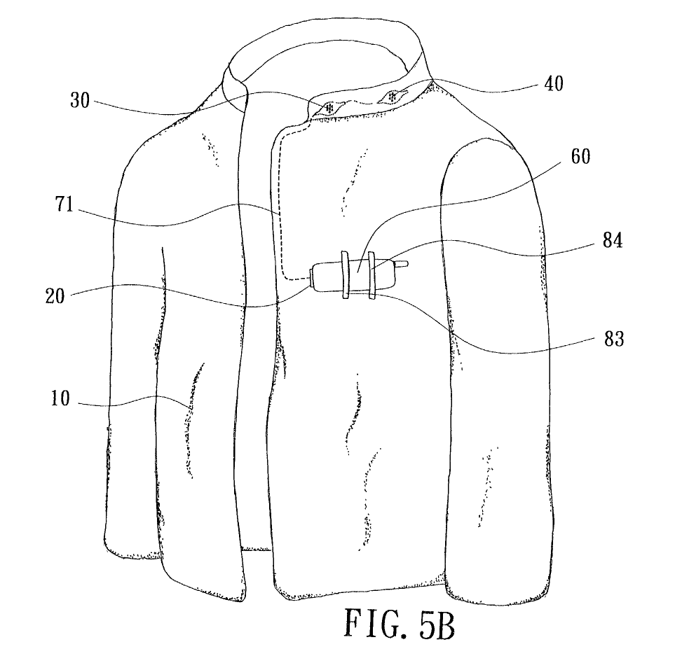

In FIG. 1, the pocket 13 is located inside the clothes 10 with the connector 20 held in the pocket 13. Hence users may directly put the mobile phone 60 in the pocket 13 to connect with the signals of the connector 20. Of course, the pocket 13 may also be located outside the clothes 10 (as shown in FIG. 3). Another alternative is to use a back clip (not shown in the drawings) which is generally provided on a general mobile phone 60 to hang the mobile phone 60 on a hanging ring 14 (as shown in FIG. 4) stitched to the clothes 10 inside or outside at a selected location closed to the connector 20. Referring to FIGS. 5A and SB, a pair of Velcro strips 83 and 84 may also be stitched to the clothes 10 inside or outside at selected locations for holding the mobile phone 60 on the clothes 10.

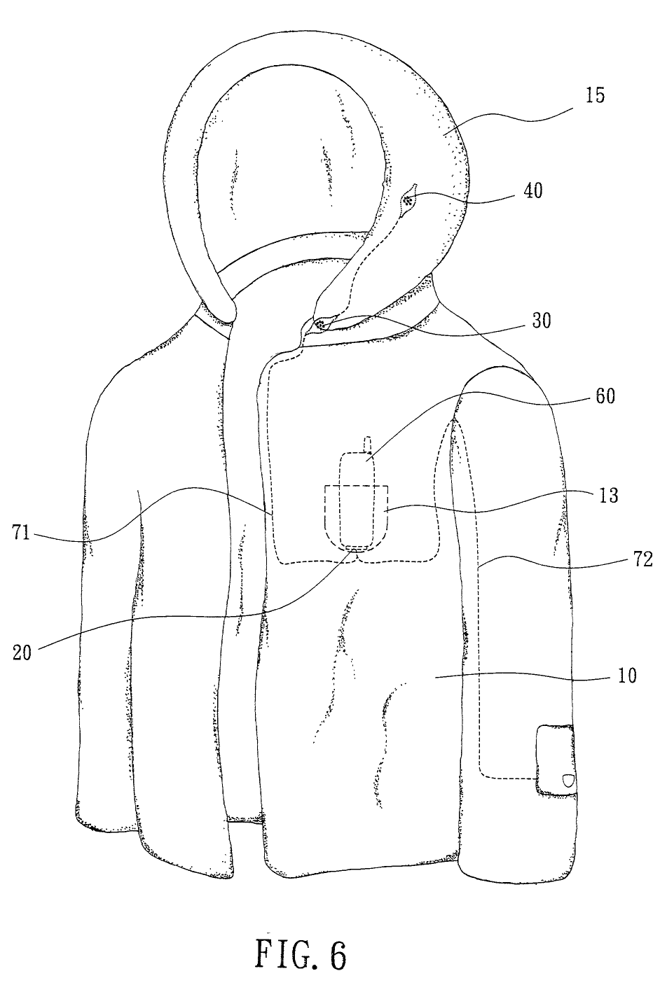

Referring to FIG. 6, the clothes 10 may also attach to a cap or hat 15 with the speaker 30 and microphone 40 hidden in the cap 15. Such a construction may fend off ambient noises or interference to get a better receiving and conversation quality.

Furthermore, to make the present invention more practical, the connector 20, speaker 30, microphone 40, keyboard 50, and wires 71 and 72 may be made waterproof, such as coating with a waterproof membrane (not shown in the drawings). The wires 71 and 72 are preferably made of conductive wires of a high flexibility, so that the clothes 10 becomes foldable and may be worn with a greater comfort.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. A communication clothes for users wearing and connecting with signals of a mobile phone, comprising:
a clothes for users wearing;
a connector disposed at a selected location on the clothes for connecting signal connection port signals of the mobile phone;
a speaker located on the clothes proximate to the ears of the users and linked to the connector for connecting the signals for generating audio signals for the mobile phone; and
a microphone located on the clothes proximate to the mouths of the users and linked to the connector for receiving users' speaking voice signals and transmitting to the mobile phone through the connector.

2. The communication clothes of claim 1, wherein the clothes is ajacket.

3. The communication clothes of claim 1, wherein the clothes is an outerwear.

4. The communication clothes of claim 1, wherein the clothes is a suit.

5. The communication clothes of claim 1 further including a keyboard attached to the clothes at a selected location and linked to the connector to form a signal connection for entering input information into the mobile phone.

6. The communication clothes of claim 5, wherein the keyboard is located on a sleeve of the clothes adjacent the sleeve opening end.

7. The communication clothes of claim 6, wherein the sleeve further has a cover flap adjacent the sleeve opening end.

8. The communication clothes of claim 7, wherein the keyboard is coverable by the cover flap.

9. The communication clothes of claim 6, wherein the sleeve adjacent the sleeve opening end and the cover flap have respectively a Velcro strip attached thereon for the cover flap to cover the keyboard and bond to the sleeve.

10. The communication clothes of claim 5, wherein the keyboard includes a plurality of push buttons, the push buttons including numeral buttons, character buttons, selection buttons, receiving buttons and cutoff buttons.

11. The communication clothes of claim 5, wherein the keyboard links to the connector through a first wire which is embedded on the stitches of a clothes rim.

12. The communication clothes of claim 1, wherein the clothes further has a hanging ring stitched thereon proximate to the connector for hanging the mobile phone.

13. The communication clothes of claim 1, wherein the clothes further has a pair of Velcro strips stitched thereon proximate to the connector for holding the mobile phone.

14. The communication clothes of claim 1, wherein the clothes has a pocket to hold the connector, the mobile phone being held in the pocket and connecting to the connector signals.

15. The communication clothes of claim 1, wherein the clothes has a collar for hiding the speaker and the microphone.

16. The communication clothes of claim 15, wherein the collar is unfoldable for moving the speaker and the microphone closed to users ears and mouths.

17. The communication clothes of claim 1, wherein the clothes further has a cap for hiding the speaker and the microphone therein and fending off ambient interference when users wearing the cap.

18. The communication clothes of claim 1, wherein the speaker and the microphone are spaced from each other for a selected distance to prevent signal interference.

19. The communication clothes of claim 1, wherein the speaker and the microphone are linked to the connector through a second wire, the second wire being embedded in the stitches of a clothes rim.
